(19) United States
(12) Patent Application Publication
(10) Pub. No.: US 2025/0285821 A1
(43) Pub. Date: Sep. 11, 2025

(54) SWITCHING DEVICE

(71) Applicant: TDK Electronics AG, Muenchen (DE)

(72) Inventors: Robert Hoffmann, Berlin (DE); Frank Werner, Berlin (DE)

(21) Appl. No.: 18/859,854

(22) PCT Filed: Apr. 28, 2023
(86) PCT No.: PCT/EP2023/061239

§ 371 Date: Oct. 24, 2024

(30) Foreign Application Priority Data
Apr. 29, 2022 (DE) 10 2022 110 496.6

(51) Int. Cl. H01H 50/14; H01H 49/00; H01H 50/02; H01H 50/54

(52) U.S. Cl. CPC H01H 50/14; H01H 49/00; H01H 2050/025; H01H 50/546

(57) ABSTRACT

In an embodiment a switching device includes at least one fixed contact projecting into a switching chamber, wherein the at least one fixed contact has a mounting part and a connection part, and wherein the mounting part is attached to the switching chamber.

### CROSS-REFERENCE TO RELATED APPLICATIONS

This patent application is a national phase filing under section 371 of PCT/EP2023/061239, filed Apr. 28, 2023, which claims the priority of German patent application 102022110496.6, filed Apr. 29, 2022, each of which is incorporated herein by reference in its entirety.

### TECHNICAL FIELD

A switching device is specified.

### BACKGROUND

The switching device is configured in particular as an electromagnetically operated, remotely actuated switch that can be operated by an electrically conductive current. The switching device can be activated via a control circuit and can switch a load circuit. In particular, the switching device can be configured as a relay or as a contactor, in particular as a power contactor. Particularly preferably, the switching device can be configured as a gas-filled power contactor.

A possible application of such switching devices, in particular power contactors, is the opening and disconnection of battery circuits, for example in motor vehicles such as electrically or partially electrically powered vehicles. These can be, for example, purely battery-powered vehicles (BEV: “Battery Electric Vehicle”), hybrid electric vehicles (PHEV: “Plug-in Hybrid Electric Vehicle”) and hybrid electric vehicles (HEV: “Hybrid Electric Vehicle”) that can be charged via a socket or charging station. As a rule, both the positive and negative contacts of the battery are disconnected using a power contactor. This disconnection takes place during normal operation, for example when the vehicle is at rest, as well as in the event of a fault such as an accident or similar. The main task of the power contactor is to de-energize the vehicle and interrupt the current flow.

A contactor typically carries high currents during operation. These are usually transmitted via supply lines such as copper bars, so-called busbars, or other supply lines that are mounted on the contacts of the contactor that can be contacted from the outside, which can also be referred to as pole contact points or terminals. The copper busbars or other supply lines can have cross-sections of over 200 mm². In order to ensure a sufficient, i.e. low-resistance electrical contact, the supply cables must be mounted with sufficiently high fastening torques, which places high mechanical demands on the pole contact points of the contactor. In addition, shear forces and lever forces can occur at the contact points during installation and subsequent operation. The contact points should therefore be made of a particularly hard but electrically conductive material.

Particularly powerful contactors have switching chambers made of ceramic materials into which the contacts are brazed at high temperatures of more than 800° C. using brazing solder. However, this process carries the risk that the material properties of most electrically conductive materials that can be used for the contacts change and the material becomes softer. It is then no longer possible to adequately secure supply cables without problems.

To avoid this problem, materials can be used that are still sufficiently hard after the soldering process to withstand the stresses. However, this usually leads to an increase in the cost of the base material used, as special copper alloys have to be used, for example. It is also known to integrate busbar pieces into a contactor, which enable additional, spatially displaced fixing points. However, this has disadvantages, such as high costs due to additional components, a higher final weight of the contactor and increased electrical contact resistance from fixing point to fixing point.

The publications JP 2005-038 706 A, JP H11-232 986 A, US 2008/0 122 562 A1, US 2016/0 012 995 A1 and DE 10 2019 129 805 B3 describe switching devices.

### SUMMARY

Embodiments provide a switching device.

According to at least one embodiment, a switching device has at least one fixed contact. The at least one fixed contact can in particular be intended and configured to connect an electrical supply line of a load circuit that is to be switched on, i.e. closed, and switched off, i.e. disconnected, by the switching device.

Furthermore, the switching device can have at least one movable contact. In particular, the movable contact may have or be a contact bridge. In other words, the contact bridge may be a movable contact of the switching device or part of a movable contact of the switching device. The properties and features of the movable contact described below can thus be corresponding properties and features of the contact bridge and vice versa.

The at least one fixed contact and the at least one movable contact are intended and configured to switch on and off a load circuit that can be connected to the switching device. The movable contact, in particular the contact bridge, is accordingly movable in the switching device between a non-through-connecting state and a through-connecting state of the switching device in such a way that the movable contact, in particular the contact bridge, is spaced apart from the at least one fixed contact in the non-through-connecting state of the switching device and is thus galvanically isolated and, in the through-connecting state, has a mechanical contact to the at least one fixed contact and is thus galvanically connected to the at least one fixed contact. In the following, the through-connecting state is also referred to as the switched-on state of the switching device, while the non-through-connecting state is referred to as the switched-off state of the switching device.

Particularly preferably, the switching device has at least two fixed contacts which are arranged separately from one another in the switching device and which can be electrically conductively connected to one another or electrically separated from one another by the movable contact, i.e. in particular the contact bridge, in the manner described above, depending on the state of the movable contact, i.e. in particular the contact bridge. The contact bridge preferably has a top side with at least one contact region and an underside opposite the top side. In the through-connecting state of the switching device, the at least one contact region of the contact bridge is in mechanical contact with the at least one fixed contact, in particular a contact region of the at least one fixed contact. If the switching device has two fixed contacts, for example, the contact bridge can have two contact regions accordingly. The features described below for one fixed contact can apply to several fixed contacts and particularly preferably to each fixed contact of the switching device.

In the following, the general term “contacts” can refer in particular to all fixed contacts as well as to the contact bridge. In particular, the contacts can be made of a metal, preferably copper or a copper alloy. Furthermore, at least for the contact regions, a composite material in the form of a metallic matrix material, preferably with or made of copper, and particles distributed therein, preferably with or made of a ceramic material such as aluminum oxide, is also possible, for example.

According to a further embodiment, the switching device has a housing in which the movable contact and the at least one fixed contact or the at least two fixed contacts are arranged. In particular, the movable contact can be arranged completely in the housing. The fact that a fixed contact is arranged in the housing can mean in particular that at least the contact region of the fixed contact, which is in mechanical contact with the movable contact in the through-connecting state, is arranged inside the housing. To connect a supply line of a circuit to be switched by the switching device, a fixed contact arranged in the housing can be electrically contacted from the outside, i.e. from outside the housing. For this purpose, a fixed contact arranged in the housing can protrude with a part out of the housing and have a connection option for an electrical supply line outside the housing.

According to a further embodiment, the contacts are arranged in a gas atmosphere in the housing. This can mean in particular that the movable contact is arranged completely in the gas atmosphere in the housing and that furthermore at least parts of the fixed contact or contacts, such as the contact region(s) of the fixed contact(s), is/are arranged in the gas atmosphere in the housing. Accordingly, the switching device can particularly preferably be a gas-filled switching device such as a gas-filled contactor.

According to a further embodiment, the switching device has a switching chamber. In particular, the switching chamber can be arranged inside the housing. In particular, the switching chamber has an interior. The contacts, i.e. the movable contact in its entirety and part of the at least one fixed contact, are arranged in the interior of the switching chamber. The at least one fixed contact thus protrudes into the switching chamber. In particular, the at least one fixed contact protrudes through an opening into the interior of the switching chamber. In other words, the at least one fixed contact is located partly inside the switching chamber and partly outside the switching chamber. For example, the switching chamber may have a switching chamber base. The switching chamber may further comprise a switching chamber cover which, together with the switching chamber base, may enclose the interior. At least in the region in which the at least one fixed contact protrudes into the switching chamber, the switching chamber is made of a ceramic material, for example with or made of aluminum oxide. For example, the at least one fixed contact can protrude through an opening in the switching chamber cover. In this case, the switching chamber cover is preferably made of the ceramic material.

A gas, i.e. at least part of the gas atmosphere described above, may be present in the switching chamber. The gas can preferably have a proportion of at least 20% H₂ and preferably at least 50% H₂. In addition to hydrogen, the gas may comprise an inert gas, particularly preferably N₂ and/or one or more noble gases.

According to a further embodiment, the movable contact in the switching device is movable by means of a shaft. In particular, the movable contact can, for example, be movable by means of a drive comprising the shaft, wherein the drive can be in the form of a magnetic drive with an armature or in the form of a motor drive. The shaft can be connected at one end to the movable contact in such a way that the movable contact can be moved by means of the shaft, i.e. it is also moved by the shaft when the shaft is moved. In particular, the shaft can protrude through an opening in the switching chamber into the interior of the switching chamber. In the case of a magnetic drive, the armature can be moved by a magnetic circuit in order to affect the switching operations described above. For this purpose, the magnetic circuit can have a yoke with an opening through which the shaft of the armature protrudes. The shaft can preferably be made of stainless steel. The yoke may preferably comprise or be made of pure iron or a low-doped iron alloy.

According to a further embodiment, the at least one fixed contact has two parts which, when joined together, essentially form the at least one fixed contact. In the switching device, the two parts are permanently joined together. Particularly preferably, the two parts are permanently joined together and thus joined in such a way that they cannot be separated from each other under normal operating conditions. Furthermore, the at least one fixed contact may comprise one or more joining materials that can improve a permanent connection of the two parts.

In particular, the at least one fixed contact has, as the two parts, a mounting part and a connection part which, when joined together, essentially form the at least one fixed contact, for example except for at least one connecting material. Particularly preferably, the connection part and the mounting part are connected to each other at least form-fitting and/or force-fitting, for example by a clamp connection or, particularly preferably, by a screw connection. Furthermore, the connection part and the mounting part can also be connected to each other by a material connection.

The mounting part is intended and configured to be attached to the switching chamber, so that the at least one fixed contact is attached to the switching chamber with the mounting part. In particular, the mounting part can be connected to the switching chamber by a material connection. The connection part is intended and configured to be connected to an external electrical supply line, so that the at least one fixed contact can be connected to an external electrical supply line with the connection part.

According to a further embodiment, the mounting part has a recess and the connection part protrudes into the recess of the mounting part. The recess can particularly preferably be configured as a blind hole so that the connection part does not protrude through the mounting part. In particular, the mounting part can be cup-shaped. The mounting part can have a contact surface on a bottom region on a side opposite the connection part, with which the mounting part and thus the at least one fixed contact is in mechanical contact with the movable contact in a through-connecting state of the switching device. The contact surface is thus arranged in the switching chamber. Consequently, the internal mechanical contact with the movable contact, as described above, is preferably made via the mounting part, whereas the external mechanical contact with an external supply line is made via the connection part.

According to a further embodiment, the connection part is accessible outside the switching device. In particular, the connection part may have a connection element that is arranged outside a housing of the switching device. The connection element can, for example, be formed by a stud bolt. Particularly preferably, the stud bolt has an external thread. Alternatively, the connection element can also have or be a threaded hole in the connection part, for example.

Furthermore, the connection part can have a support element from which the connection element extends away. In particular, the connection element can extend away from the support element in a direction facing away from the mounting part. For this purpose, the support element can particularly preferably have a top side facing away from the switching chamber, from which the connection element protrudes.

The support element can, for example, be disc-shaped, preferably in the form of a circular disc from which the connection element, for example in the form of a stud bolt, protrudes centrally. The connection element can be provided for positioning, arranging and attaching an external electrical supply line. If the connection element has an external thread, a fastening nut can be screwed onto the connection element, for example. The top side of the support element can form a support surface for the external electrical supply line, against which the external electrical supply line is pressed in an attached state, for example when the fastening nut is tightened, in order to achieve the lowest possible electrical contact resistance between the at least one fixed contact and the first electrical supply line. The external electrical supply line can therefore, for example, have a hole through which the connection element protrudes and can also be clamped between the support element and a fastening nut screwed onto the connection element.

According to a further embodiment, the connection part has a connection element. The connection element is preferably arranged on a side of the support element opposite the connection element. The connection element can, for example, be formed by a stud bolt. In particular, the connection element can extend in a direction facing the mounting part when viewed from the support element. For this purpose, the support element can particularly preferably have an underside facing the switching chamber, from which the connection element protrudes.

In particular, the connection element can protrude into the recess of the mounting part and especially preferably be arranged in the recess. The connection part can particularly preferably be screwed into the recess with the connection element. For this purpose, the connection element can have an external thread and the recess in the mounting part can have an internal thread. Particularly preferably, the connection element and the connection element can each have an external thread with the same thread size.

According to a further embodiment, the external thread of the connection element and/or the internal thread of the recess have an interference fit before the connection part is screwed into the mounting part. In other words, the internal thread of the recess has a smaller tolerance than the external thread of the connection element. The threads preferably comply with the standards DIN 13-1 to DIN 13-52, particularly preferably DIN 13-51 (transition tolerance zone for tight fit). For example, a fit “M8-5H/4h” (transition fit) may be present. The DIN 13 standards generally refer to fine threads such as threads of type M6, M8 etc. Other thread types are also included, such as non-metric thread types, for example in accordance with ASME B1.1, and special threads, for example in accordance with DIN 7756 and valve threads. By screwing the connection element into the recess, a tighter screw connection can be achieved due to the oversize, which can prevent unintentional unscrewing of the connection part from the mounting part.

According to a further embodiment, a connecting material is arranged between the external thread of the connection element and the internal thread of the recess. The connecting material can have an adhesive or be an adhesive, for example with or made of an acrylate such as a methacrylate or a cyanoacrylate.

According to a further embodiment, a connecting material is arranged in the recess below the connection element. For this purpose, the recess can particularly preferably have a depth that is greater than a height of the connection element measured from the underside of the support element, so that when the connection part is completely screwed into the mounting part, a cavity remains below the connection element in which the connecting material can be arranged. The connecting material can comprise an adhesive, for example an adhesive described above, or a soft solder or be made of it. Soft solder is referred to here and in the following as a solder that preferably has a melting point of less than or equal to 400° C. The soft solder can, for example, be arranged in the form of a soldering pill in the recess of the mounting part that is already attached to the switching chamber. After screwing in the connection part, the soft solder can be melted by heating, for example in an oven. The soft solder can be free of flux. Alternatively, the soft solder can be provided with a flux. A flux can, for example, improve the wetting properties of the soft solder. The soft solder can preferably be lead-free. For example, the soft solder may contain or consist of one or more materials selected from bismuth (Bi), tin (Sn) and antimony (Sb). The proportions, based on the mass, can for example be greater than or equal to 25% and less than or equal to 35% for bismuth and tin and particularly preferably greater than or equal to 27% and less than or equal to 31% for antimony and greater than or equal to 50% and less than or equal to 70% and particularly preferably greater than or equal to 38% and less than or equal to 46% for antimony. Furthermore, the soft solder may, for example, contain or consist of one or more materials selected from tin (Sn), silver (Ag) and copper (Cu). The proportions, based on the mass, can be greater than or equal to 50% for tin, for example, and particularly preferably greater than or equal to 85%. The proportions based on the mass of silver can be less than 15% and preferably less than 5%. The proportions, based on the mass, for copper can be less than 5% and preferably less than 1%. For example, the soft solder can be Sn96.5Ag3.0Cu0.5.

According to a further embodiment, the underside of the support element rests on the mounting part. The mounting part can have an edge region with a top side on which the underside of the support element rests. The edge region can particularly preferably be formed around the recess in the mounting part.

According to a further embodiment, a connecting material is arranged between the underside of the support element and the top side of the edge region. For example, the connecting material can have or be a soft solder, for example a soft solder as described above.

According to a further embodiment, the top side of the edge region of the mounting part and/or the underside of the support element of the connection part has a surface structure, for example a knurling and/or a roughening. The surface structure can be provided particularly preferably in connection with a connecting material between the underside of the support element and the top side of the edge region.

According to a further embodiment, the support element is welded to the edge region. In particular, the support element can be connected to the edge region by means of a weld seam on an outer side of the contact region, which is formed by the underside of the support element and the top side of the edge region, wherein the weld seam can particularly preferably be completely circumferential.

One or more of the aforementioned connecting materials and/or the surface structure and/or the welding can improve the fastening of the connection part to the mounting part. This can reduce or even prevent the risk of unintentional loosening of the connection part from the mounting part.

The support element and the edge region can particularly preferably have the same outer diameter. The top side of the edge region and the underside of the support element can, for example, both be ring-shaped and arranged congruently with one another. Furthermore, the support element and the edge region can each be partially arranged in an opening in a housing of the switching device. In particular, the contact region between these, i.e. the top side of the edge region and the underside of the support element, can be arranged within the opening of the housing.

According to a further embodiment, the edge region has a fastening edge facing the switching chamber, which is connected to the switching chamber by a material connection. In other words, the fastening edge is arranged opposite the top side. In particular, the fastening edge can be connected to the switching chamber by means of a hard solder, wherein the at least one fixed contact is attached to the switching chamber. The switching chamber can have a corresponding edge region around the opening through which the at least one fixed contact, i.e. in particular the mounting part, projects into the switching chamber, which can be formed, for example, by a raised ring structure and to which the fastening edge is attached by means of the brazing solder. The term brazing solder is used here and in the following to refer to a solder that has a melting point of greater than or equal to 600° C. For example, a solder based on silver and/or copper can be used as a brazing alloy, particularly preferably a silver-copper alloy such as Ag72Cu28.

According to a further embodiment, the connection part and the mounting part are made of the same material. In particular, the connection part and the mounting part can each have or be made of a material generally mentioned above for the contacts, for example a metal, preferably copper or a copper alloy. In the installed state, i.e. when the at least one fixed contact is attached to the switching chamber, the mounting part can have a lower hardness than the connection part. This can be achieved by soldering the mounting part to the switching chamber using the brazing solder. Due to the typically high temperature of, for example, 800° C. or more during brazing, the material of the mounting part can be softer after brazing than before due to solid-state physical processes. The connection part, on the other hand, can retain its original hardness as it is not subjected to a brazing process but is screwed in after brazing.

In the switching device described here, one or more fixed contacts, which form the attachment points for external electrical supply lines, are thus configured in two parts, wherein only one, preferably small, part of each of the fixed contacts is actually soldered in by means of brazing and a second part, which does not undergo the soldering process, is added later. This has the advantage that there is no weight disadvantage compared to conventional one-piece contacts, the contact resistance does not increase or increases only slightly due to preferably the same materials and nevertheless an increased mechanical strength is achieved compared to one-piece fixed contacts. The measures described above allow the second part to be securely attached to the soldered-in first part. As a result, the fixed contacts and the switching device described here can be manufactured inexpensively with little or no increase in process costs and higher mechanical loads are possible compared to one-piece fixed contacts.

### BRIEF DESCRIPTION OF THE DRAWINGS

Further advantages, advantageous embodiments and further developments are revealed by the embodiments described below in connection with the figures.

FIGS. 1A and 1B show schematic illustrations of an embodiment of a switching device;

FIGS. 2A to 2E show schematic illustrations of a fixed contact of the switching device;

FIGS. 3A and 3B show schematic illustrations of a method for mounting a fixed contact on the switching chamber cover of the switching device according to a further embodiment; and

FIGS. 4 to 8B show schematic illustrations of a fixed contact of the switching device according to further embodiments.

In the embodiments and figures, identical, similar or identically acting elements are provided in each case with the same reference numerals. The elements illustrated and their size ratios to one another should not be regarded as being to scale, but rather individual elements, such as for example layers, components, devices and regions, may have been made exaggeratedly large to illustrate them better and/or to aid comprehension.

### DETAILED DESCRIPTION OF ILLUSTRATIVE EMBODIMENTS

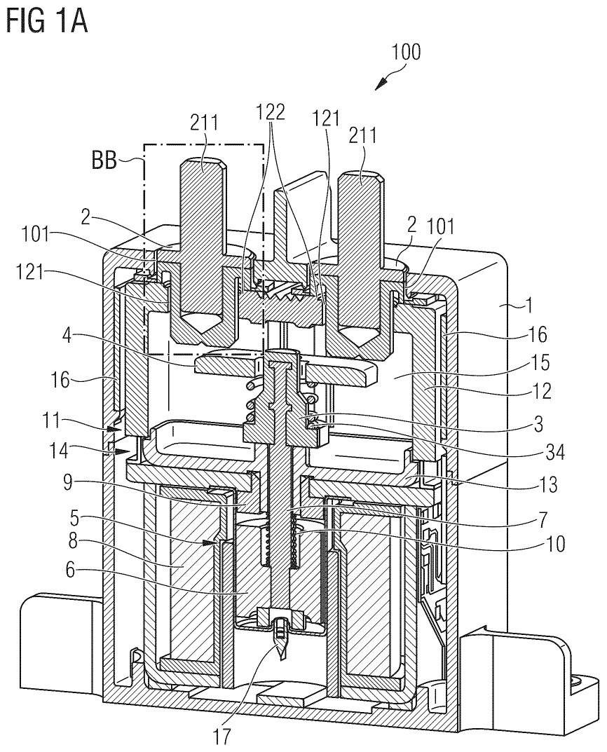

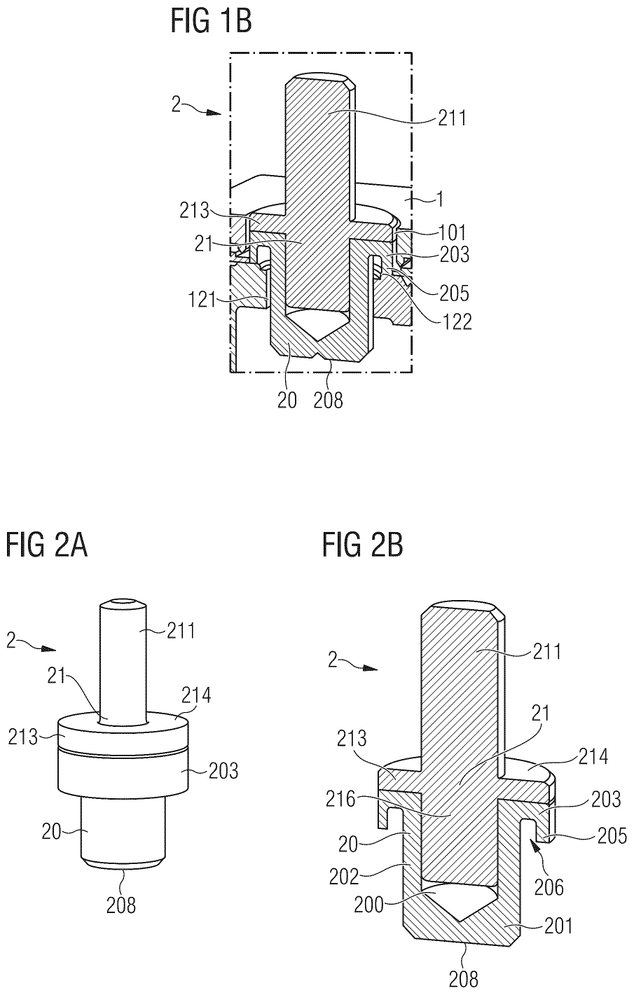

FIGS. 1A and 1B show an embodiment of a switching device 100 which can be used, for example, for switching strong electrical currents and/or high electrical voltages and which can be a relay or contactor, in particular a power contactor. FIG. 1A shows a three-dimensional sectional view with a vertical sectional plane. In FIG. 1B, the section BB marked in FIG. 1A is shown enlarged. The geometries shown are only exemplary and are not to be understood as limiting and can also be configured alternatively.

The switching device 100 has contacts 2, 4 in a housing 1, which are also referred to below as switching contacts. The housing 1 serves primarily as contact protection for the components arranged inside and has a plastic or is made of plastic, for example PBT or glass fiber-filled PBT. In the example shown, the switching device 100 has two fixed contacts 2 and a movable contact mounted on an insulator 3 in the form of a contact bridge 4. The contact bridge 4 is configured as a contact plate. The fixed contacts 2 together with the contact bridge 4 form the switching contacts. As an alternative to the number of contacts shown, other numbers of contacts, i.e. other numbers of fixed and/or movable contacts, are also possible. The fixed contacts 2 and/or the contact bridge 4 can, for example, be made with or of Cu, a Cu alloy or a mixture of, for example, copper with at least one other metal, for example Wo, Ni and/or Cr.

In FIG. 1A, the switching device 100 is shown in an off state, in which the contact bridge 4 is spaced apart from the fixed contacts 2, so that the contacts 2, 4 are electrically isolated from each other. In order to set the switching device 100 to a switched-on state, the contact bridge 4 in the illustration shown must be moved upwards in the direction towards the fixed contacts 2 until the contact bridge 4 is in mechanical contact with the fixed contacts 2. In the embodiment shown, the switching device 100 has a magnetic drive with a movable armature 5, which essentially performs the switching movement. The armature 5 has a magnetic core 6, for example with or made of a ferromagnetic material. Furthermore, the armature 5 has a shaft 7 which is guided through the magnetic core 6 and is firmly connected to the magnetic core 6 at one end of the shaft. At the other end of the axis, opposite the magnetic core 6, the armature 5 has the contact bridge 4. The shaft 7 can preferably be made with or of stainless steel.

To electrically insulate the contact bridge 4 from the shaft 7, the insulator 3, which can also be referred to as a bridge insulator, is arranged between them. To help compensate for possible height differences and to ensure sufficient mechanical contact between the fixed contacts 2 and the contact bridge 4, a contact spring 34 is arranged below the contact bridge 4, which is supported on the insulator 3 and exerts a force on the contact bridge 4 in the direction of the fixed contacts 2.

The magnetic core 6 is surrounded by a coil 8. A current flow in the coil 8, which can be switched on externally by a control circuit, generates a movement of the magnetic core 6 and thus of the entire armature 5 in the axial direction until the contact bridge 4 makes contact with the fixed contacts 2. In the illustration shown, the armature 5 moves upwards for this purpose. The armature 5 thus moves from a first position, a rest position, which corresponds to the disconnected, i.e. non-through-connecting and thus switched-off state, to a second position, which corresponds to the active, i.e. through-connecting and thus switched-on state. In the active state, the switching contacts are galvanically connected to each other.

To guide the shaft 7 and thus the armature 5, the switching device 100 has a yoke 9, which may be made of pure iron or a low-doped iron alloy and which forms part of the magnetic circuit. The yoke 9 has an opening in which the shaft 7 is guided. Furthermore, a guide sleeve (not shown) may be present in the opening of the yoke 9, for example. If the current flow in the coil 8 is interrupted, the armature 5 is moved back into the first position by one or more springs 10. In the illustration shown, the armature 5 thus moves downwards again. The switching device 100 is then back in the rest state, in which the contacts are open.

When opening the switching contacts, for example, at least one electric arc can occur, which can damage the contact surfaces of the switching contacts. As a result, there may be a risk that the switching contacts “stick” to each other due to welding caused by the electric arc and can no longer be separated from each other. The switching device 100 is then still in the switched-on state, although the current in the coil 8 is switched off and the load circuit should therefore be disconnected. In order to prevent the formation of such arcs or at least to support the extinguishing of arcs that occur, the switching contacts can be arranged in a gas atmosphere, so that the switching device 100 can be configured as a gas-filled relay or gas-filled contactor. In particular, the switching contacts are arranged within a switching chamber 11, for example formed by a switching chamber cover 12 and a switching chamber base 13, in a gas-tight region 14 formed by a hermetically sealed part, wherein the switching chamber 11 may be part of the gas-tight region 14. The gas-tight region 14 completely surrounds the armature 5 and the switching contacts, except for parts of the fixed contacts 2 intended for external connection. The gas-tight region 14 and thus also the interior 15 of the switching chamber 11 are filled with a gas. The gas-tight region 14 is essentially formed by parts of the switching chamber 11, the yoke 9 and additional walls. The gas, which can be filled into the gas-tight region 14 through a gas filling nozzle 17 as part of the manufacture of the switching device 100, can particularly preferably contain hydrogen, for example with 20% or more H₂ in an inert gas or even with 100% H₂, since hydrogen-containing gas can promote the extinguishing of arcs. Furthermore, so-called blow magnets, i.e. permanent magnets 16, can be present inside or outside the switching chamber 11, which can cause the arc gap to be extended and thus improve the extinguishing of the arcs.

The switching chamber cover 12 and the switching chamber base 13 can, for example, be made with or from a ceramic material such as a metal oxide, for example Al₂O₃. Furthermore, plastics with a sufficiently high temperature resistance, for example a PEEK, a PE and/or a glass fiber-filled PBT, are also suitable, for example for the switching chamber base 13. Alternatively or additionally, the switching chamber 11 can also at least partially comprise POM, in particular with the structure (CH₂O)ₙ. Such a plastic can be characterized by a comparatively low carbon content and a very low tendency to form graphite. Due to the equal proportions of carbon and oxygen, particularly in (CH₂O)ₙ, gaseous CO and H₂ can be predominantly produced during heat-induced and, in particular, arc-induced decomposition. The additional hydrogen can increase the arc extinction. Particularly preferred are the switching chamber cover 12 made of a ceramic material and the switching chamber base 13 made of a ceramic material or a plastic according to the description above.

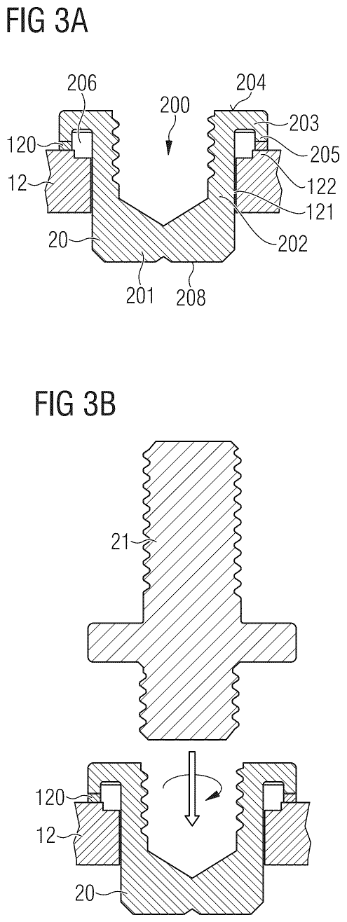

The fixed contacts 2 are arranged in openings 121 of the switching chamber cover 12 and protrude through the openings 121 into the interior 15 of the switching chamber 11, so that in particular the contact surfaces 208 of the fixed contacts 2 are arranged in the interior 15 of the switching chamber 11. The fixed contacts 2 are mounted permanently in a material-connection manner and, in particular, gas-tightly on a mounting region 122 of the switching chamber cover 12 that extends around the openings 121. Particularly preferably, the fixed contacts 2 are mounted on the switching chamber 11 by brazing. For this purpose, the fixed contacts 2, which have a mounting part 20 and a connection part 21, have an edge region 203 with a fastening edge 205, between which and the mounting region 122 a brazing solder (not shown) is arranged. For example, a solder based on silver and/or copper can be used as the brazing solder, particularly preferably a silver-copper alloy such as Ag72Cu28. Method steps of a method for mounting the fixed contacts 2 on the switching chamber cover 12 are described in connection with FIGS. 3A and 3B.

To connect the fixed contacts 2 to external electrical supply lines (not shown) of a load circuit, these protrude through openings 101 in the housing 1, as indicated in FIGS. 1A and 1B, and have connection elements 211 outside the housing 1, which are configured for example as so-called stud bolts, to which external supply lines such as supply rails, so-called busbars, or cable lugs are mounted. As explained in connection with the following figures, the connection elements 211 can have a thread, so that the external supply lines can be fixed to the connection elements 211 and thus to the fixed contacts 2 by means of screw nuts, for example, and pressed against support elements 213. In order to achieve the lowest possible electrical contact resistance between the external supply lines and the fixed contacts 2 and to ensure a permanent mechanical connection, even with shear forces and lever forces that can occur during operation, a sufficiently high tightening torque is required with which the screw nuts are screwed onto the connection elements 211. Therefore, the connection elements 211 in particular must have sufficient mechanical strength. In other words, the material of the connection elements 211 must be sufficiently hard. However, as described at the beginning, in the case of a conventional fixed contact, the brazing process for fastening the fixed contact would lead to a change and in particular softening of the material.

The fixed contacts 2 are therefore formed in two parts in the switching device 100 shown. Further features and embodiments of the fixed contacts 2 are explained in connection with the following figures.

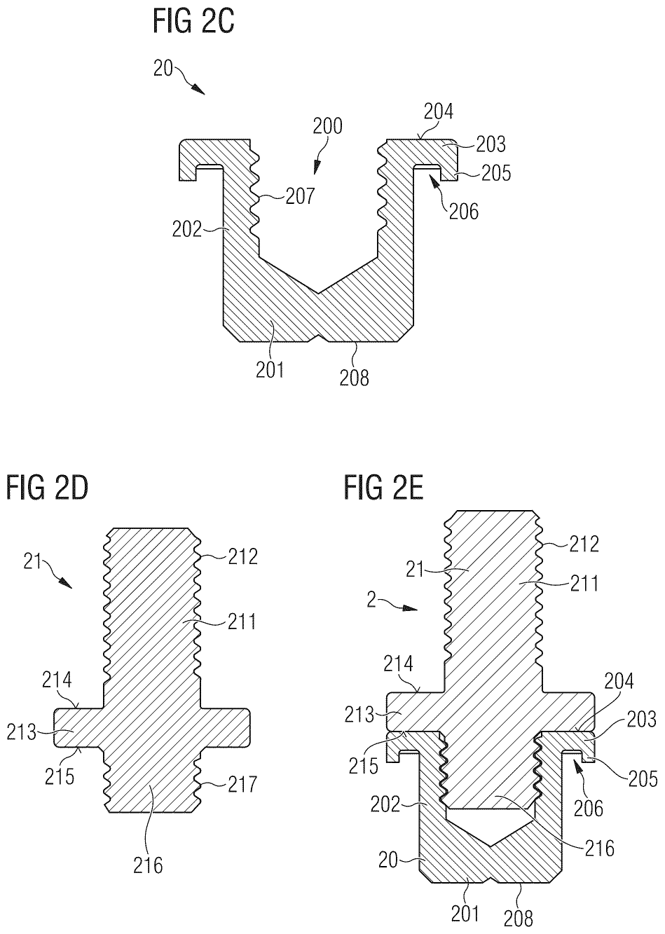

FIGS. 2A to 2E show different views of a fixed contact 2 corresponding to the two fixed contacts 2 of the switching device 100 according to the embodiment of FIGS. 1A and 1B. In other words, the fixed contacts 2 of the switching device 100 may be formed like the fixed contact 2 as described in FIGS. 2A to 2E. FIGS. 2A and 2B show a three-dimensional top view and a three-dimensional sectional view of the fixed contact 2, respectively. FIGS. 2C to 2E show various other sectional views of the fixed contact 2 or parts thereof. The following description refers equally to FIGS. 2A to 2E.

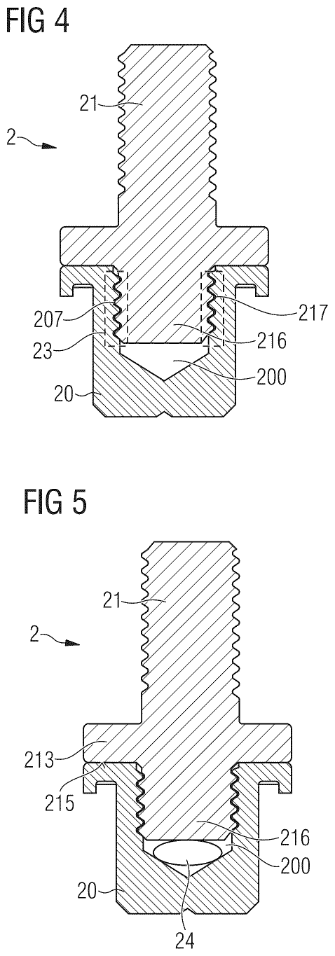

As described in connection with FIGS. 1A and 1B, the fixed contact 2 has two parts, formed by a mounting part 20 and a connection part 21, which, when joined together, essentially form the at least one fixed contact 2 and which are permanently joined together in the switching device. Particularly preferably, the connection part 21 and the mounting part 20 are connected to each other at least form-fitting and/or force-fitting, for example by a clamp connection or, particularly preferably, by a screw connection. Furthermore, the connection part 21 and the mounting part 20 can also be connected to each other by a material connection, as described in connection with FIGS. 4 to 8B.

The mounting part 20 is intended and configured to be attached to the switching chamber by means of brazing, as described in connection with FIGS. 1A and 1B, so that the fixed contact 2 is attached to the switching chamber with the mounting part 20. The connection part 21 is intended and configured to be connected to an external electrical supply line, as described in connection with FIGS. 1A and 1B, so that the fixed contact 2 can be connected to an external electrical supply line with the connection part 21.

The mounting part 20 has a recess 200 and the connection part 21 protrudes into the recess 200 of the mounting part 20. The recess 200 is configured as a blind hole so that the connection part 21 does not protrude through the mounting part 20. In particular, the mounting part 20 can be cup-shaped with a bottom region 201 and an adjoining wall region 202. The contact surface 208 is provided on the bottom region 201 on a side opposite the connection part 21.

The connection part 21 has the connection element 211 formed as a stud bolt, which, as shown in FIGS. 1A and 1B, is arranged outside the housing of the switching device and has an external thread 212. The connection element 211 extends away from a top side 214 of the support element 213 in a direction facing away from the mounting part 20. As can be seen in FIG. 2A, the support element 213 is particularly preferably disk-shaped, particularly preferably in the form of a circular disk from which the connection element 211 protrudes centrally.

Furthermore, the connection part 21 has a connection element 216. The connection element 216 is arranged on a side of the support element 213 opposite the connection element 211 and is configured as a stud bolt, which protrudes from an underside 215 of the support element 213 facing the switching chamber, so that the connection element 216 extends in a direction facing the mounting part 20 when viewed from the support element 213.

The connection element 216 protrudes into the recess 200 of the mounting part 20 and is arranged in it. The connection part 21 is screwed into the recess 200 with the connection element 216. For this purpose, the connection element 216 has an external thread 217. The recess 200 in the mounting part 20 has a matching internal thread 207 in the wall region 202. For example, the connection element 211 and the connection element 216 can each have an external thread 212, 217 with an identical thread size, for example of the size M8. In particular, the external threads 212, 217 can have the same direction of rotation and thus both be a right-hand thread, for example.

Furthermore, the external thread 217 of the connection element 216 and/or the internal thread 207 of the recess 200 can have an interference fit, as described above in the general part, before the connection part 21 is screwed into the mounting part 21, wherein a tighter screw connection can be achieved, by which an unintentional unscrewing of the connection part 21 from the mounting part 20 can be prevented.

After screwing in the connection part 21, the support element 213 preferably rests with the underside 215 on the mounting part 20. For this purpose, the mounting part 20 can in particular have the edge region 203 with a top side 204, on which the underside 215 of the support element 211 rests, so that the best possible electrical contact can be achieved between the mounting part 20 and the connection part 21. The edge region 203 can particularly preferably be formed circumferentially around the recess 200 in the mounting part 20.

The support element 211 and the edge region 203 can particularly preferably have the same outer diameter. The top side 204 of the edge region 203 and the underside 215 of the support element 211 can, for example, both be annular in shape and arranged congruently with one another. As can be seen in FIGS. 1A and 1B, the support element 211 and the edge region 203 can each be arranged partially in the opening in the housing of the switching device. In particular, the contact region between these, i.e. the top side 204 of the edge region 203 and the underside 215 of the support element 213, can be arranged within the opening in the housing.

As described in connection with FIGS. 1A and 1B, the edge region 203 has a fastening edge 205 facing the switching chamber, which is connected to the switching chamber by a material connection. The fastening edge 205 can, for example, be spaced from the wall region 202 by a circumferential groove 204. FIGS. 3A and 3B show method steps of a method for mounting the fixed contact 2 on the switching chamber cover 12, which can be carried out for all fixed contacts 2 as part of the manufacture of the switching device.

As shown in FIG. 3A, the mounting part 20 is inserted into the opening 121 of the switching chamber cover 12 in such a way that the fastening edge 205 is arranged on the mounting region 122. The mounting region 122 can, for example, be formed in an edge region of the opening 121 by a raised ring structure. A brazing solder 120 is applied between the mounting region 122 and the fastening edge 205, for example a solder based on silver and/or copper and particularly preferably a silver-copper alloy such as Ag72Cu28. The switching chamber cover 12 can be heated with the mounting parts 20 of all fixed contacts 2 arranged in this way, for example in an oven, so that a gas-tight connection is formed between the switching chamber cover 12 and the mounting parts 20 by the brazing solder 120 melting and re-solidifying. Then, as indicated in FIG. 3B, a connection part 21 can be screwed into each mounting part 20.

The connection part 21 and the mounting part 20 are particularly preferably made of the same material, for example with or made of a metal, preferably oxygen-free copper or a copper alloy. In the installed state, i.e. when the fixed contact 2 is attached to the switching chamber, the mounting part 20 may have a lower hardness than the connection part 21 due to the brazing process. Due to the typically high temperature of, for example, 800° C. or more during brazing, the material of the mounting part 20 may be softer after brazing than before due to solid-state physical processes. The connection part 21, on the other hand, can retain its original hardness since it is not subjected to a brazing process but is screwed in after brazing.

While the mounting part 20 is therefore soldered to the switching chamber cover and can become softer in the process, the connection part 21 made of the same material remains untreated, as it is only attached subsequently. The T-shape of the harder connection part 21, which can be seen in the cross-section of FIG. 2E, favors the frictional connection with the mounting part 20 and prevents shear forces, which can later act on the connection element 211, from damaging the internal thread 207 of the mounting part 20 via a leverage effect. It has been shown that even with a relatively low tightening torque of around 4 Nm, the electrical contact resistance added by the two-part shape of the fixed contact 2 is negligible.

FIGS. 4 to 8B below show further embodiments of the fixed contact 2 according to further embodiments, which can improve a permanent connection between the mounting part 20 and the connection part 21. For the sake of clarity, only the elements described are marked with reference symbols in FIGS. 4 to 8B. The measures described can be used alone or in combination.

As shown in FIG. 4, a connecting material 23 can be arranged between the external thread 217 of the connection element 216 of the connection part 21 and the internal thread 207 of the recess 200 of the mounting part 20, as indicated by the dashed regions. The connecting material 23 may comprise an adhesive or be an adhesive, for example with or made of an acrylate such as a methacrylate or a cyanoacrylate. The adhesive can harden after mounting the connection part 21 on the mounting part 20 and prevent the connection part 21 from unintentionally unscrewing.

As shown in FIG. 5, a connecting material 24 can be arranged in the recess 200 below the connection element 216 of the connection element 21. For this purpose, the recess 200 particularly preferably has a depth which is greater than a height of the connection element 216 measured from the underside 215 of the support element 213, so that when the connection part 21 is completely screwed into the mounting part 20, a cavity remains below the connection element 216, in which the connecting material 24 can be arranged. The connecting material 24 may comprise or consist of an adhesive, for example an adhesive described above, or particularly preferably a soft solder. The soft solder may, for example, be arranged in the form of a soldering pill in the recess 200 of the mounting part 20, which is already attached to the switching chamber. After screwing in the connection part 21, the soft solder can be melted by heating, for example in an oven, wherein the temperature required for this is significantly lower than in the hard soldering process and does not result in softening of the connection part 21. The soft solder can preferably be lead-free and, for example, based on Bi, Sn and/or Sb or based on Sn and Ag and/or Cu, as described above in the general part. The soft solder can be free of flux so that no flux residues remain in the cavity. Alternatively, the soft solder can be provided with a flux. A flux can, for example, improve the wetting properties of the soft solder.

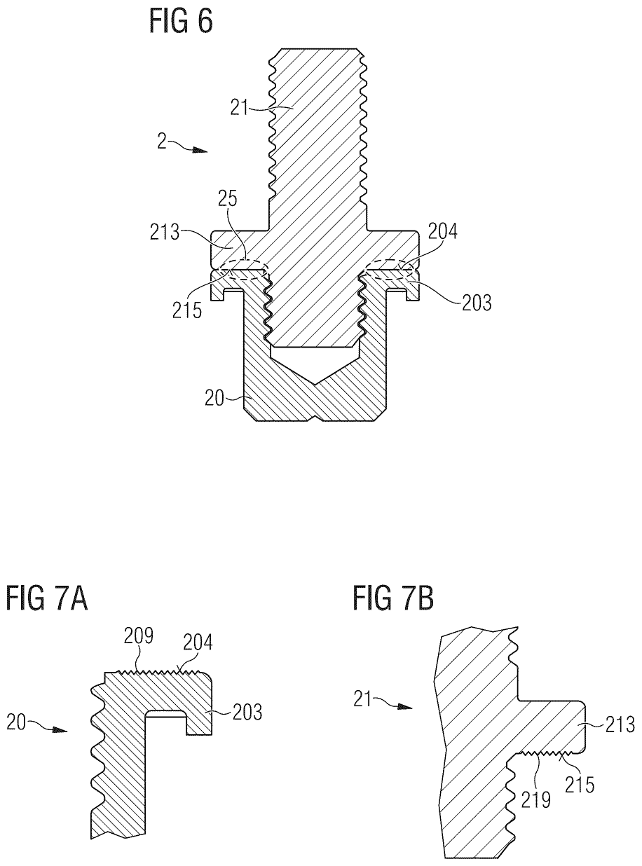

As shown in FIG. 6, a joining material 25 may be disposed between the underside 215 of the support element 213 of the connection part 21 and the upper surface 204 of the edge region 203 of the mounting part 20. For example, the connecting material 25 may comprise or be an adhesive or, particularly preferably, a soft solder as described above.

Thus, for the embodiments shown in FIGS. 5 and 6, before the connection part 21 is screwed onto the mounting part 20, a connecting material 24, 25, particularly preferably in the form of a soft solder, can be applied either close to the thread in the recess 200 or on the outer edge, i.e. on the bearing surface formed by the top side 204 of the edge region 203. For example, after assembly of the connection part 21, a solder containing a flux can be brought to its melting temperature, which is preferably less than or equal to 300° C., which leads to melting and subsequently to a firm connection. The low melting temperature of the soft solder avoids a reduction in the hardness of the connection part 21, as this would typically only occur with copper and copper alloys at temperatures of more than 500° C. During operation of the switching device, the temperatures of the fixed contact 2 typically remain at less than 160° C., which prevents the soft solder from melting again. The introduction of the joining material 25 at the outer edge has the advantage that it increases the torque required to release the soft solder connection.

Furthermore, as shown in FIGS. 7A and 7B, the top side 204 of the edge region 203 of the mounting part 20 and/or the underside 215 of the support element 213 of the connection part 21 may have a surface structure 209, 219, for example a knurling and/or a roughening, which may be produced by sandblasting, for example. The surface structure 209, 219 can be provided particularly preferably in conjunction with a connecting material 25 between the underside 215 of the support element 213 and the top side 204 of the edge region 203.

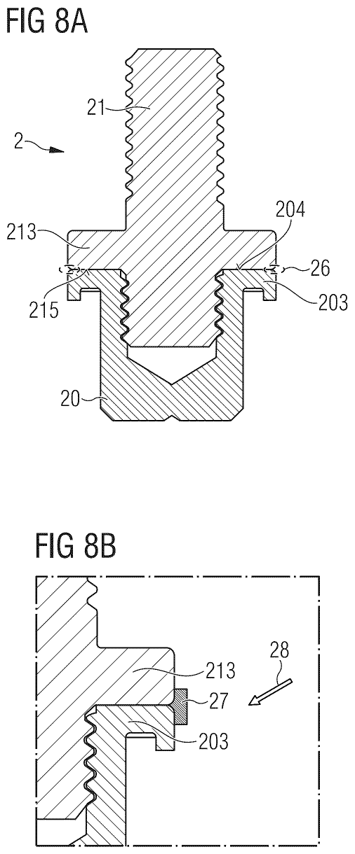

As shown in FIGS. 8A and 8B, the support element 213 of the connection part 21 can be welded to the edge region 203 of the mounting part 20. After screwing the connection part 21 to the mounting part 20, the contact edge is circumferentially or partially welded at the edge for this purpose. In particular, the support element 213 can be connected to the edge region 203 by means of a weld seam 26, which is indicated by the dashed area in FIG. 8A, on an outer side of the contact region, which is formed by the underside 215 of the support element 213 and the top side 204 of the edge region 203, wherein the weld seam 26 can particularly preferably be completely circumferential. The weld seam 26 can particularly preferably be formed by laser welding. Welding has the advantage of a short process time. Furthermore, a high level of safety against unintentional detachment of the connection part 21 from the mounting part 20 during use of the switching device can be achieved.

The surfaces of the parts to be joined can be prepared in such a way that laser beams can effectively introduce energy and reflection of the beams can be prevented. As indicated in FIG. 8B, an absorption element 27 can be arranged in the welding area for this purpose, which can be formed by a suitable paint, varnish or roughening, for example.

The features and embodiments described in connection with the figures can be combined with each other according to further embodiments, even if not all combinations are explicitly described. Furthermore, the embodiments described in connection with the figures may alternatively or additionally have further features as described in the general part.

The invention is not limited by the description based on the embodiments to these embodiments. Rather, the invention includes each new feature and each combination of features, which includes in particular each combination of features in the patent claims, even if this feature or this combination itself is not explicitly explained in the patent claims or embodiments.

1-20. (canceled)

21. A switching device comprising:
at least one fixed contact projecting into a switching chamber,
wherein the at least one fixed contact has a mounting part and a connection part, and
wherein the mounting part is attached to the switching chamber.

22. The switching device according to claim 21, wherein the connection part and the mounting part are made of the same material.

23. The switching device according to claim 22, wherein the mounting part has a lower hardness than the connection part.

24. The switching device according to claim 21, wherein the connection part protrudes into a recess in the mounting part.

25. The switching device according to claim 24, wherein the mounting part is cup-shaped and the recess is a blind hole.

26. The switching device according to claim 24, wherein the connection part projects with a connection element into the recess of the mounting part and is screwed into the recess with the connection element.

27. The switching device according to claim 26, wherein the connection element has an external thread and the recess in the mounting part has an internal thread.

28. The switching device according to claim 27, wherein the external thread and/or the internal thread has an interference fit before the connection part is screwed into the mounting part and/or a connecting material is arranged between the external thread and the internal thread, the connecting material comprising an adhesive.

29. The switching device according to claim 24, wherein a connecting material is arranged in the recess below the connection part, the connecting material comprising a soft solder.

30. The switching device according to claim 21, wherein the connection part comprises a connection element, which is arranged outside a housing of the switching device, and which is a stud bolt.

31. The switching device according to claim 30, wherein the connection part comprises a support element from which the connection element extends away.

32. The switching device according to claim 31, wherein the support element has an underside facing the switching chamber, with which the connection part rests on the mounting part.

33. The switching device according to claim 32, wherein the mounting part comprises an edge region with a top side on which the underside of the support element rests.

34. The switching device according to claim 33, wherein the switching device comprises the housing in which the switching chamber is arranged, and wherein the top side of the edge region and the underside of the support element are arranged within an opening of the housing.

35. The switching device according to claim 33, wherein the top side of the edge region of the mounting part and/or the underside of the support element of the connection part has a surface structure.

36. The switching device according to claim 35, wherein the surface structure comprises a knurling and/or a roughening.

37. The switching device according to claim 33, wherein a connecting material is arranged between the underside of the support element and the top side of the edge region.

38. The switching device according to claim 37, wherein the connecting material comprises a soft solder.

39. The switching device according to claim 33, wherein the support element is welded to the edge region.

40. The switching device according to claim 33, wherein the edge region has a fastening edge facing the switching chamber, which is connected to the switching chamber in a material-connected manner.
